(19) United States
(12) Patent Application Publication
(10) Pub. No.: US 2012/0062933 A1
(43) Pub. Date: Mar. 15, 2012

(54) CONTROLLED JOB RELEASE IN PRINT MANUFACTURING

(76) Inventors: Jun Zeng, Sunnyvale, CA (US); Eric Hoarau, San Francisco, CA (US); I-Jong Lin, Half Moon Bay, CA (US)

(21) Appl. No.: 12/879,085

(22) Filed: Sep. 10, 2010

(51) Int. Cl. G06F 3/12

(52) U.S. Cl. 358/1.15

(57) ABSTRACT

Controlled job release in print manufacturing is disclosed. An exemplary method includes stochastically receiving a plurality of print jobs in a job buffer. The method also includes analyzing factory management parameters. The method also includes generating automated control parameters based on the print jobs in the job buffer and the analyzed factory management parameters. The method also includes releasing the print jobs from the job buffer in a controlled manner using the automated control parameters.

### BACKGROUND

Despite the “electronic age,” there is still demand for print products. Commercial print has annual retail sales over US $700 B. Print service providers (PSPs) fulfill the demand for print products by printing everything from photographs and brochures, course materials, periodicals and books, to advertisements and product packaging. In a modern PSP facility, print manufacturing is shifting toward an on-demand manufacturing paradigm, such as producing photo-books based upon customer orders. One characteristic of such on-demand business is the tight linkage between the customer demand and the manufacturing activity.

Typically, customer demand patterns are random in nature, in addition to secular trends and seasonal trends. Secular trends may include, for example, the surge in demand for personalized photo-books due the developments in technology, such as mass availability of the digital camera. Seasonal trends may include, for example, the so-called “holiday quarter” spanning from before Thanksgiving through the New Year in the United States. Other demand variation may occur within the same week, for example, with on-line ordering patterns being concentrated earlier in the week just after the weekend.

The uncertainty and variability of the demand is one of the principal sources negatively impacting manufacturing productivity and capacity planning for PSPs. Typically, PSPs use peak demand as a reference for capacity planning and factory design. This means that higher volatility in demand results in over-planning (e.g., higher machine over-capacity, and/or higher supply inventory) when compared to lower volatility demand which results in longer cycle time and associated lower grade of service for the same averaged throughput level. Demand variations force the manufacturing system to include substantial excess capacity. Accordingly, lean manufacturing calls for smooth flow—ideally flat and with uniform product mix to avoid surging.

These deviations of real-time operations from a smooth demand flow (so-called “zero surging”) is particularly acute in the digital printing arts, which are often one-time production jobs and much more susceptible to variable demand and short turn-around times as compared with other manufacturing processes. Other manufacturing processes for example, may order large equipment months or even years in advance, and have single products that can be manufactured for longer cycles (e.g., weeks, or even months, sometimes longer) and can thus be better planned for.

### BRIEF DESCRIPTION OF THE DRAWINGS

FIG. 1 is a block diagram illustrating an exemplary PSP.

FIG. 2 is another block diagram illustrating exemplary PSP operations.

FIG. 3 is a high-level block diagram of a system which may implement controlled job release in print manufacturing.

FIG. 4 shows exemplary analysis modules which may be implemented by the job release application 400.

FIG. 5a is a graphical representation comparing print jobs being released to the factory floor as soon as they are admitted, with print jobs being released according to a TAKT time/quantity-only approach.

FIG. 5b is a graphical representation showing oscillation in inventory build-up.

FIGS. 6a-b is a graphical representation showing an example where implementing PID control reduced the inventory build-up by at least 50%.

FIG. 7 is a flowchart illustrating exemplary operations which may be implemented for controlled job release in print manufacturing.

### DETAILED DESCRIPTION

Today, PSP facilities have neither direct impact nor accurate knowledge of customer demands. Furthermore, in digital print, every print job is potentially different. A term dubbed to describe such extreme customization in digital print, “every page is different” (EPID) indicates that from the print manufacturer's perspective, digital print factories do not have the option of pre-fabricating products (or significant portions thereof) to build an inventory to meet forecasted demand or a surge in demand, as other manufacturing sectors are able to do.

To resolve the conflict between stochastic demand patterns and a “just-in-time” (JIT) call for smooth production flow, a control-theoretic based automated job release mechanism is disclosed which dispatches print jobs to the factory floor. Embodiments are disclosed which generate a demand buffer between the incoming print jobs and the print factory processing. The job release mechanism works with optimized factory management methods to achieve smooth production flow and comply with other productivity objectives, such as, service level agreement, quality assurance goals, and target throughput.

An exemplary embodiment includes determining timing and quantity of job release, and automating the generation of control parameters through initial factory production characterization, artificial intelligence (AI)-based real-time training, or both. Accordingly, the systems and methods disclosed herein may reduce or altogether eliminate the adverse effects of variable demand, and improve factory scheduling, production planning, workflow management system, simulation aided decision-making, optimization, knowledge discovery, and monitoring and tracking.

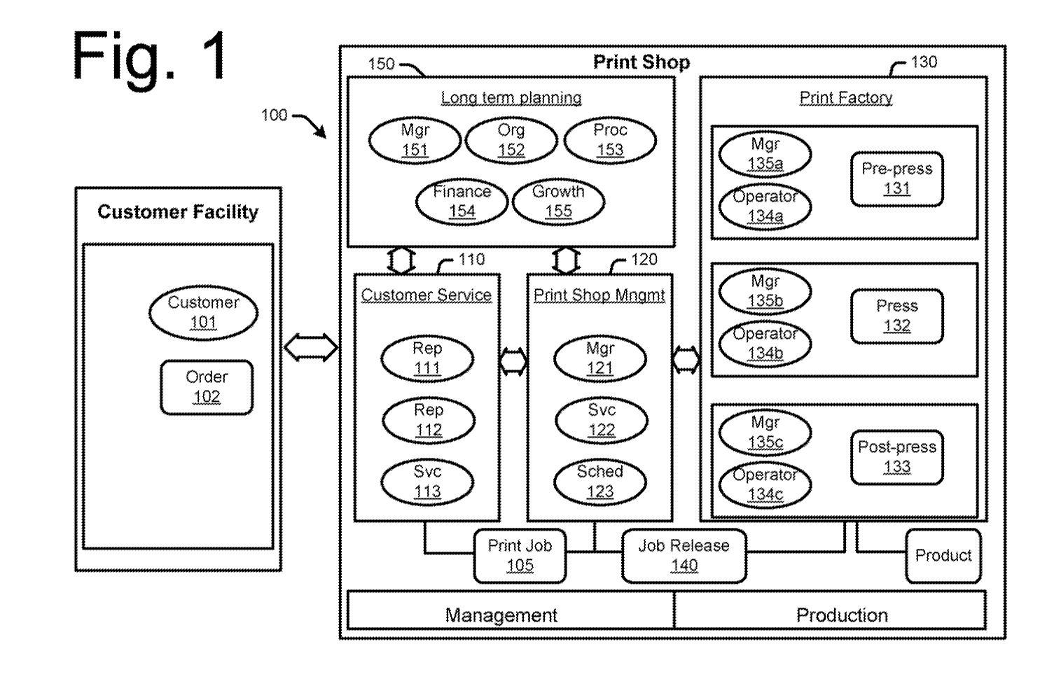

FIG. 1 is a block diagram illustrating an exemplary PSP 100. Also shown in FIG. 1 is a customer 101. The customer 101 may be an individual, a group of individuals, or an organization (non-profit, small business, corporation, and the like).

Although not typically well-suited to an individual, the PSP 100 may function to process print jobs for multiple individuals, such as, the customers of a large retailer, wherein the large retailer takes orders from the individuals (e.g., for photo calendars) and submits the order as a batch of individual customer orders to the PSP 100. In this illustration, the customer 101 is the large retailer submitting the order on behalf of many individuals. Of course the systems and methods described herein are not limited to any particular type or size of customer or customers, and may also be utilized with individual customers 101 of the PSP 100.

In general, the customer 101 creates the material to be printed (e.g., the photographs and brochures, course materials, periodicals and books, to advertisements and product packaging) or works with a third-party provider to generate the material to be printed. The customer 101 then submits an order 102 including one or more materials for the PSP 100 to print, along with one or more print parameters (e.g., substrate stock, number of copies, due date, any special instructions such as laminating and quality level, and shipping information).

The PSP 100 receives and converts the customer's order 102 to a print job 105 as part of customer service 110. A “print job” 105 may include some or all of the print parameters from the order 102, but may also include one or more other parameters, such as prioritizing the print job 105. These priorities may be the same, or different from any priorities specified by the customer 101. For example, meeting the due date may be the same priority for the PSP 100 as for the customer 101. However, the PSP 100 may assign another priority for completing the order 102 prior to the due date, which may be different from one customer 101 to the next (e.g., a repeat and high-volume customer 101 may receive a higher priority from the PSP 100 than a first-time or low-volume customer 101). The print job 105 may also include other parameters assigned by the PSP 100, for example, based on current backlog, supplies in stock, and so forth.

Customer service 110 may also include sales representatives 111, customer service representatives 112, and automated services 113 that are responsible for advertising and promoting the PSP 100, handling customer complaints, pricing/bidding orders 102, maintaining vendor relations, ordering supplies for the PSP 100, and so forth.

In addition to interfacing with the customer 101, customer service 110 also interfaces with print shop management 120. For example, customer service 110 provides the print job 105 to the print shop management 120 and communicates with the print shop management 120 to ensure that customer expectations are met. Customer service 110 may also assign one or more parameters to the print job 105 based on feedback from the print shop management 120.

Print shop management 120 includes one or more print shop managers 121 and automated services 122 that are responsible for overseeing operations of the print factory 130, including production scheduling 123. The print shop management 120 is assisted in this regard by controlled job release system 140 and methods disclosed herein and described in more detail below.

Print shop management 120 also communicates with long term planning 150. Long term planning 150 may include management 151 (e.g., executive-level managers) who are responsible for site organization 152, process definition 153, finances 154, and growth strategy 155, among other things.

The print factory 130 may include a number of production operations, including pre-press production 131, press production 132, and post-press production 133. During pre-press production 131, the print job is converted to the perquisite format (e.g., an electronic bitmap file). During press production 132, the print job is printed on the printing machines. And during post-press production 133, the print job is finished by laminating, cutting, collating, binding, sorting/binning, packaging, and shipping. Quality Assurance (QA) may also be implemented during one or more of the production operations. Each of the production operations may include automated processes and/or manual processes, and in either case, operators 134a-c and their respective line managers 135a-c.

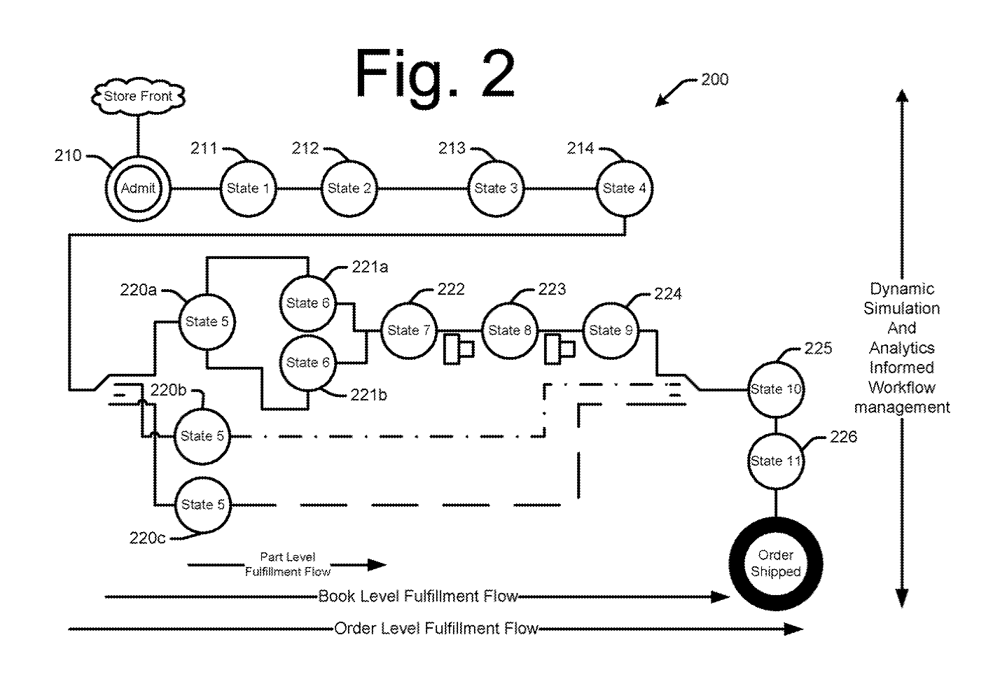

FIG. 2 is a workflow diagram 200 illustrating exemplary states of PSP operations. The pre-press, press, post-press, and shipping operations have already been discussed above for the respective components of the PSP facility shown in FIG. 1, and therefore the description of these is not repeated here. FIG. 2 show the dynamic simulation and analytics which may be integrated with workflow software for implementation across the various production operations up to and including shipping to provide an overview how and where the controlled job release system and methods described herein may be implemented.

The “store front” of the PSP (e.g., the customer relations) admits print jobs to the factory floor at 210. For this example, the print job is a book printing. At 211, the digital files for the book may be downloaded, and at 212 “pre-flighted” for the printing operations. Orders are combined/split and otherwise scheduled at 213, and the raster image is processed at 214. Next, a switch may be implemented to select between different paths 220a-c. If path 220a is selected, the cover may be printed at 221a, or a book block may be printed at 221b. The parts are sorted at 222, the book is bound at 223, and the book is cut at 224. The books may then be sorted at 225, and packaged/labeled for shipping at 226. The order is then shipped to the customer. The simulation and analytics described herein can be used for a sub-system or for the full end-to-end system.

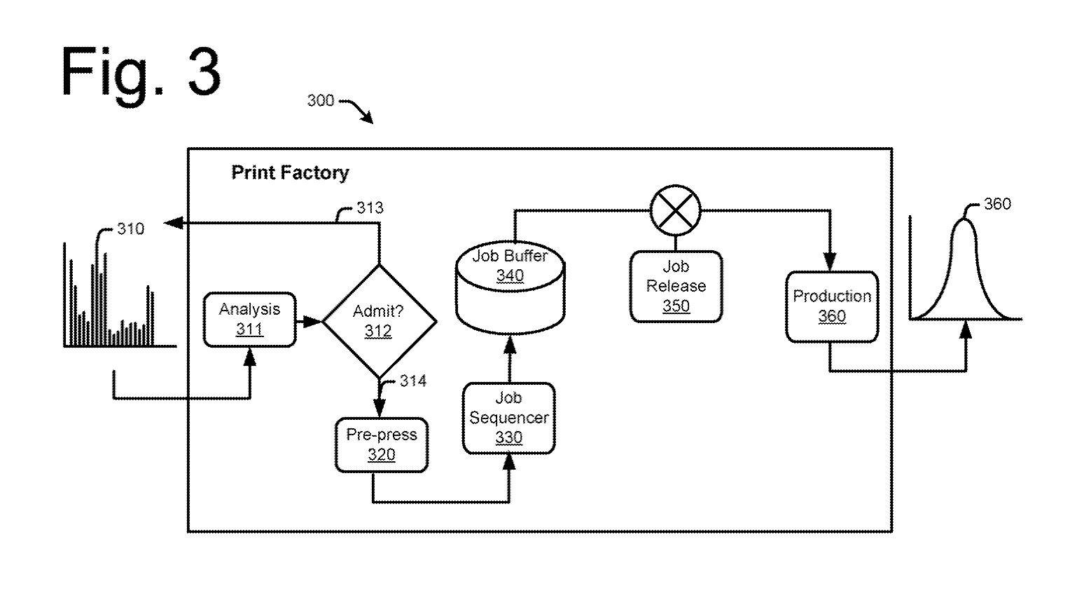

FIG. 3 is a high-level block diagram of a system 300 which may implement controlled job release in print manufacturing. The non-deterministic or stochastic incoming demand is illustrated by plot 310, and according to the embodiments described herein, may be analyzed upon receipt at block 311. The analysis at block 311 may include, for example, whether the print job can be fulfilled based on current capabilities and capacity, whether the due date allows sufficient time to process the job given current operating conditions at the factory floor, whether the associated image files are correct for the printing process, and so forth. A determination is made at decision block 312 if the print job meets the print factory's admission requirement and is either returned via arrow 313 to customer service to work with the customer on resubmission of the order, or is admitted via arrow 314 to the pre-press process 320.

During the pre-press process 320, the payload profile may be estimated based on a number of factors including, for example, which fulfillment tasks need to be exercised by which print machines, and the time, labor and resource costs. The job payload profile may then be coupled with a due date and a factory capacity map. The factory capacity map may include, for example, on the automated side, the number and types of print machines and associated capacity and capability; and on the manual side, headcount and expertise of the operators.

Information from the pre-press process 320 is passed to the job sequencer 330. Job sequencer 330 prioritizes print jobs. For example, job sequencer 330 may prioritize print jobs based on any of a wide variety of different parameters, such as job value, customer ranking, due date, and current and forecasted print factory operating conditions, to name only a few examples. Job sequencer 330 then admit the prioritized print jobs to job buffer 340.

The job buffer 340 may be implemented as a computer-readable storage configured to temporarily hold the admitted print jobs before the print jobs are released to the factory floor. A control-theoretic based job release mechanism 350 may analyze the print jobs in the job buffer 340. A job stream or “workload” can be extracted as a function of time, wherein the job release mechanism 350 determines a release schedule indicating when and how many print jobs to be released to the factory floor (and/or to other print factories) so that the print jobs can be released to the factory floor for production (block 360) in a controlled manner, as illustrated by the output plot 370.

The release schedule is derived from real-time and/or historic information collected from the PSP facility (and/or multiple facilities). The information may be aggregated via a suitable networked computer system. The networked computer system may include one or more communication networks, such as a local area network (LAN) and/or wide area network (WAN). A host may be implemented in the networked computer system. Host may include one or more computing systems, such as a server with computer-readable storage. Host may execute a job release application implemented in software or other program code to accomplish the job release mechanism 350, as described in more detail below.

In an exemplary embodiment, networked computer system may also include a web portal on a third-party venue (e.g., a commercial Internet site), which facilitates a connection for one or more clients with the host (e.g., via a back-end link). In another exemplary embodiment, portal icons may be provided (e.g., on third-party venues, pre-installed on computer or appliance desktops, etc.) to facilitate a direct link to the host.

The term “client” as used herein refers to a computing device through which one or more users (e.g., print shop management, production operators and their managers) may access the job release service. Client computing devices may include any of a wide variety of computing systems, such as a stand-alone personal desktop or laptop computer (PC), workstation, personal digital assistant (PDA), or appliance, to name only a few examples. Each of the client computing devices may include memory, storage, and a degree of data processing capability at least sufficient to manage a connection to the job release application. Client computing devices may connect to the network via a communication connection, such as wired or wireless network access.

As previously mentioned, the job release application may be implemented in program code which may have any suitable form, including but not limited to, computer software, web-enabled or mobile applications or “apps”, so-called “widgets,” and/or embedded code such as firmware. Although the program code may comprise a number of components or modules for purposes of illustration herein, the program code is not so limited. The program code may include additional components, modules, routines, subroutines, etc. In addition, one or more functions may be combined into a single component or module.

The job release application includes program code executable to store a plurality of stochastically received print jobs in a job buffer. The program code is also executable to analyze factory management parameters. Automated control parameters may be generated based on the print jobs in the job buffer and the analyzed factory management parameters. A release schedule and timing is output by the program code for the print jobs in the job buffer using the automated control parameters. Accordingly, the release schedule reduces variation in job flow.

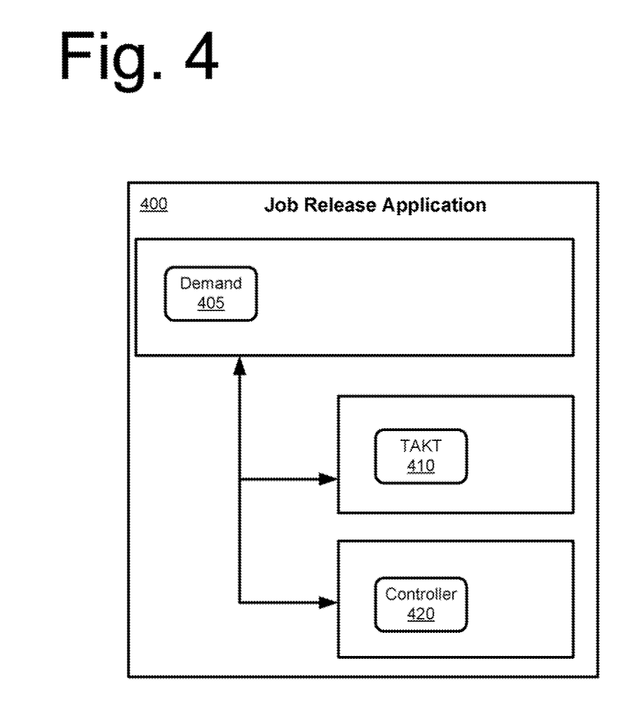

FIG. 4 shows exemplary implementation of the control-theoretic based modules which may be implemented by the job release application 400. Job release may be controlled for any given demand 405 in part by TAKT time and TAKT quantity-based job release module 410, and in part by one or more other controller 420. This TAKT time and TAKT quantity-based job release module is implemented and discussed here to provide the performance comparison.

TAKT is the maximum time per unit allowed to produce a product in order to meet demand, and is commonly used for pace setting in a variety of industrial manufacturing processes. For purposes of illustration, consider an assembly line, where parts that are assembled on a line are moved from one station to the next after a predetermined time, calculated as the TAKT time. Accordingly, the time allotted to complete work at each station has to be less than the TAKT time in order to meet the production schedule.

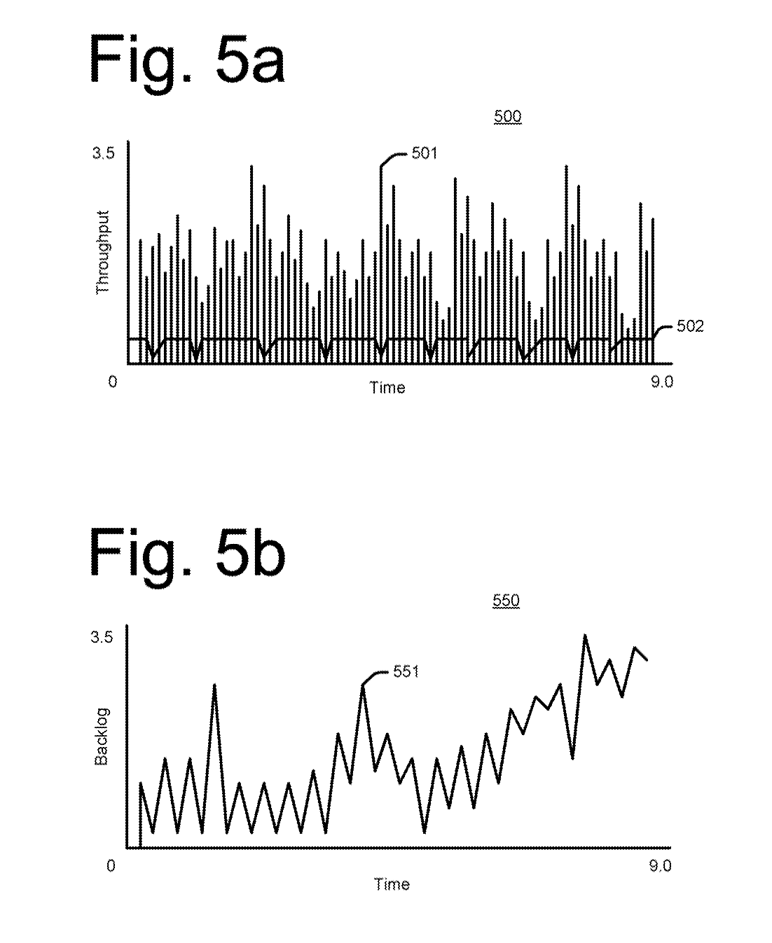

The TAKT approach helps reduce the un-controllable demand variation that is common in the print industry for the reasons already discussed above. However, in the print industry a strictly TAKT time/quantity based approach still results in “surging”. The TAKT time/quantity needs to be frequently adjusted, and is typically done manually by the floor manager. This results in a step function with either varying frequency (changing TAKT time), or varying magnitude (changing TAKT quantity), or both. Performance can be seen by the plots shown in FIGS. 5a-b.

FIG. 5a is a graphical representation 500 of throughput on the y axis as a function of time on the x-axis. Plot 500 compares print jobs being released to the factory floor as soon as they are admitted (i.e., no job release control) as shown by plot 501, with print jobs being released according to a TAKT time/quantity-only approach as shown by plot 502. It can be seen that the TAKT time/quantity based job release control reduces the flow variation by more than 85% in this example.

While the TAKT time/quantity based job release control successfully reduces the demand for excessive over-capacity, a strictly TAKT time/quantity-based job release control does not help control inventory build-up. That is, the TAKT time/quantity are determined by the averaged demand pattern. Therefore, the intrinsic demand variation throws the control method off-balance from time to time, as can be seen in FIG. 5b. FIG. 5b is a graphical representation 550 showing a plot 551 of the oscillation in inventory build-up. The accumulative effect is the build-up of the job inventory over time.

Therefore (returning again to FIG. 4), the job release application 400 may also implement a release analysis module 420. Release analysis module 420 extracts or predicts long-term demand throughput and determines the cycle time needed to meet this demand. In one example, a Proportional Integral Derivative (PID) controller is implemented to monitor the inventory build-up and provide corrective action as a component to the job release control.

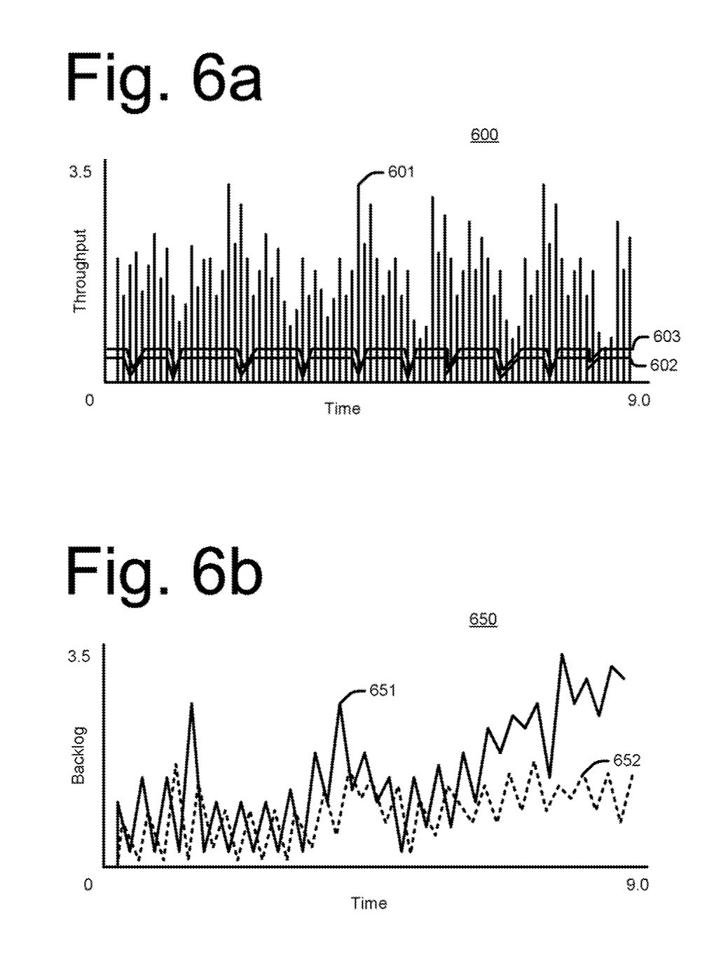

Such an augmented approach to job release control inherits the benefit of the TAKT time/quantity based job release control (i.e., reducing job flow variation). But in addition, also reduces inventory build up. FIGS. 6a-b are graphical representations 600 of throughput on the y axis as a function of time on the x-axis. Similar to plot 500, plot 600 compares print jobs being released to the factory floor as soon as they are admitted (i.e., no job release control) as shown by plot 601, with print jobs being released according to a TAKT time/quantity-only approach as shown by plot 602. It can be seen that the TAKT time/quantity based job release control reduces the flow variation by more than 85% in this example. A PID approach achieved similar results. In addition, the graphical representation 650 shows a plot 651 of the oscillation in job flow when only implementing the TAKT time/quantity approach, but an inventory build-up reduction of about 50% as shown by plot 652 when also implementing a PID controlled release. In addition, when implementing the PID controlled release, the inventory reduction is adaptive and automated, thereby eliminating the need for human intervention.

Before continuing, it should be noted that although a TAKT time/quantity module and a PID controller is discussed above, any suitable controller may be implemented by itself or in combination with one or more other controllers. By way of example, a feedback PID control, linear and nonlinear controls (e.g., sliding mode control), adaptive control, AI-based control (e.g., neural networks, Bayesian probability, fuzzy logic, machine learning, genetic algorithms), stochastic control, model predictive control (MPC), and other control algorithms may be implemented depending on design considerations, as will be readily appreciated by those having ordinary skill in the art after becoming familiar with the teachings herein.

In addition to monitoring and better controlling the inventory build-up as shown in the aforementioned example, other print factory metrics can also be used (either alone or collectively) as the control input signal. For example, the difference between the output job flow (measured at the shipping station) and the averaged demand throughput may be used.

Furthermore, job release control can also include a feedback loop to inform the job admission process. For example, the utilization rate of the bottleneck may be monitored. When the utilization rate of the bottleneck approaches one and there is much less over-capacity in the system, the job release control can inform the job admission process to admit only high-value jobs.

Again, the automatic generation of the control parameters can be by automated “training” using past demand profiles, adaptive algorithms, AI-based algorithms, or embedded simulation to aid parameter generation, to name only a few examples. Accordingly, the automated job release control can be implemented. by PSPs to reduce or altogether manual decision-making.

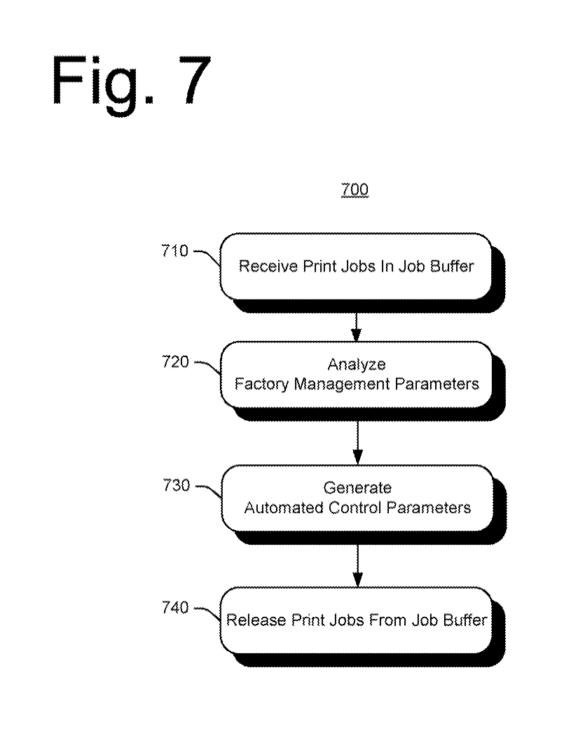

FIG. 7 is a flowchart illustrating exemplary operations which may be implemented for controlled job release in print manufacturing. Operations 700 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used for controlled job release in print manufacturing.

In operation 710, a plurality of print jobs are received in a job buffer. The print jobs are typically received stochastically. That is, there is little predictability in the order, type, quantity, schedule, etc. of print jobs being received.

In operation 720, factory management parameters are analyzed. Factory management parameters may include, but are not limited to available facility or facilities, facility organization, facility operations (e.g., current and planned utilization of printing machine(s) and manual labor), supplies/backorders, facility pre-press, press, and post-press processing, facility QA level. Factory management parameters are not limited to only to current print jobs being handled at a facility (or facilities), but may also include requested or job-specific parameters (e.g., a particular substrate stock, deadline for completion of the job). One or more of the factory management parameters may be analyzed according to any suitable algorithm, as discussed in more detail above.

The analysis may take into consideration real-time and/or historical data. Historical data may be, for example, a moving or “running average,” job-specific statistics, or other statistical analysis. In an embodiment, historical data may include a particular customer's history. In another embodiment, historical data may include a job-type history (e.g., based on similar job-type such as “course materials” or “brochures”). In another embodiment, historical data may include a combination of customer-specific and job-type history, for example, where the customer is a repeat-customer but without a sufficiently large history for accurate analysis.

In operation 730, automated control parameters are generated based on the print jobs in the job buffer and the analyzed factory management parameters. Automated control parameters for a print job may include, but are not limited to, print shop management (e.g., scheduling printing machine(s) and manual labor to be utilized) and production management (e.g., speed and timing of pre-press operations, press operations, and post-processing). In operation 740, the print jobs are released from the job buffer in a controlled manner using the automated control parameters.

The operations shown and described herein are provided to illustrate exemplary implementations of controlled job release in print manufacturing. It is noted that the operations are not limited to the ordering shown. Still other operations may also be implemented.

It is noted that the exemplary embodiments shown and described are provided for purposes of illustration and are not intended to be limiting. Still other embodiments are also contemplated.

1. A method of controlled job release in print manufacturing, comprising:
stochastically receiving a plurality of print jobs in a job buffer;
analyzing factory management parameters;
generating automated control parameters based on the print jobs in the job buffer and the analyzed factory management parameters; and
releasing the print jobs from the job buffer in a controlled manner using the automated control parameters.

2. The method of claim 1, wherein the factory management parameters include at least one of the following: machine status, machine throughput, machines online, machines offline, print job scheduling, pending service requests, employee status, employee throughput, total employees, employee experience, employee scheduling, availability of material, and type of supplies.

3. The method of claim 1, wherein analyzing the factory management parameters includes a combination of real-time data and historical data.

4. The method of claim 1, wherein analyzing the factory management parameters uses at least one of: feedback proportional integral and derivative (PID) control, linear control, non-linear control, adaptive control, artificial intelligence-based control, stochastic control, and model predictive control (MPC).

5. The method of claim 1, wherein analyzing the factory management parameters uses a heuristic approach.

6. A job release system for use in print manufacturing, comprising:
a job buffer configured to receive a plurality of stochastic print jobs;
an analyzer configured to apply factory management parameters to the stochastic print jobs;
a generator configured to output automated control parameters based on the print jobs in the job buffer and the factory management parameters; and
a control mechanism operatively associated with the generator, the control mechanism deterministically releasing print jobs from the job buffer based on the automated control parameters from the generator.

7. The system of claim 6, further comprising a feedback loop providing the real-time factory management parameters to the analyzer.

8. The system of claim 6, further comprising an interface configured to receive input from a user at the analyzer.

9. The system of claim 6, further comprising a simulator configured to predict demand pattern for receiving print jobs.

10. The system of claim 6, further comprising a simulator configured to forecast factory operating conditions.

11. The system of claim 6, wherein the factory management. parameters include historical data.

12. The system of claim 11, wherein the historical data includes customer-specific historical data.

13. The system of claim 11, wherein the historical data includes customer-specific historical data and generic job-type historical data when the customer lacks historical data for analysis.

14. A print manufacturing system including program code stored in computer-readable storage and executable by a processor to control job release by:
storing a plurality of stochastically received print jobs in a job buffer;
analyzing factory management parameters;
generating automated control parameters based on the print jobs in the job buffer and the analyzed factory management parameters; and
outputting a release schedule for the print jobs in the job buffer using the automated control parameters, the release schedule reducing variation in job flow.

15. The system of claim 14, wherein the program code is further executable to generate a corrective action flag based on factory management parameters.

16. The system of claim 14, wherein the program code is adaptive to current factory management parameters.

17. The system of claim 14, wherein the program code is further executable to reduce build-up in the job buffer.

18. The system of claim 14, wherein the program code is further executable to reorder print jobs in the job buffer based on job value.

19. The system of claim 14, wherein the factory management parameters include job-specific parameters.

20. The system of claim 14, further comprising a Proportional Integral Derivative (PID) controller to monitor inventory build-up and provide corrective action as a component to job release control.
